(19) United States
(12) Patent Application Publication
(10) Pub. No.: US 2016/0333905 A1
(43) Pub. Date: Nov. 17, 2016

(54) MODULAR SYSTEM FOR FORMING AN EXITING FLOWPATH IN A FLUID DISPLACEMENT DEVICE AND IMPLEMENTATION THEREOF

(71) Applicant: Howden Roots LLC, Wilmington, DE (US)

(72) Inventor: Dale Eugene Husted, Centerville, IN (US)

(21) Appl. No.: 14/710,774

(22) Filed: May 13, 2015

(51) Int. Cl. F15D 1/00

(52) U.S. Cl. CPC F15D 1/0015

(57) ABSTRACT

A system for configuring a flowpath in a compressor. The flowpath is configured to direct working fluid from an impeller inside of a volute casing member to a nozzle member on the compressor. In one embodiment, the system can include a first member and a second member, each being removebly replaceable from the volute casing member of the compressor. In use, changes in one or both of the first member and the second member define geometry for the flowpath to match the frame size of the impeller with the flow parameters of flow that exits the compressor.

### BACKGROUND

The subject matter disclosed herein generally relates to fluid displacement devices and machinery that use rotating elements to act on working fluids, with particular discussion about a system with modular components to configure such machinery to maintain efficiency at different setpoints.

Fluid displacement devices can be used to deliver working fluid as an exit flow at pressure, flow rate, and related flow parameters or “setpoints” as desired. In use, these devices can be configured with components in order to achieve a range of flow parameters. However, these components may not necessarily configure the fluid displacement device to operate efficiently for all setpoints found within the operating range. The device may instead require different components that are better suited to achieve the setpoints for the exit flow. Unfortunately, this requirement can complicate manufacture and assembly, as well as to increase inventory of parts at the manufacturer because it necessitates multiple part numbers for each and every different component and/or combination thereof. Moreover, the need to use unique combinations of components on compressors to maintain efficiency can also frustrate steps to repair, refurbish, and/or re-commission such fluid displacement devices for different applications.

### BRIEF DESCRIPTION OF THE INVENTION

This disclosure describes embodiments of a system that can modularize construction of fluid displacement devices and also maintain operating efficiency of the fluid displacement devices for different flow parameters. As used herein, the term “fluid displacement devices” can embody machinery that acts on a working fluid, for example, to distribute the working fluid under pressure. This machinery can embody pumps, compressors (e.g., centrifugal compressors), and blowers, wherein at least one difference between these different types of machinery resides in the operating pressures of the exit flow that discharges from the machinery, e.g., to a process line.

The embodiments can include an impeller, a volute casing member, and a pair of replaceable members that insert into the volute casing member. The volute casing member can have dimensions that are fixed to receive different combinations of the replaceable members. In use, the replaceable members define geometry for a flowpath that directs working fluid from the impeller to exit the compressor as the exit flow. Changes in one or both of the replaceable members define geometry for the flowpath that better matches the other components (e.g., the impeller) to the flow parameters of the exit flow.

### BRIEF DESCRIPTION OF THE DRAWINGS

Reference is now made briefly to the accompanying drawings, in which:

FIG. 1 depicts a schematic diagram of an elevation view of the partial cross-section of an exemplary embodiment of a flow directing system for use in a compressor;

FIG. 2 depicts a detail view of the flow directing system of FIG. 1;

FIG. 3 depicts a perspective view of an exemplary embodiment of a flow directing system for use in a compressor, shown in partially assembled form;

FIG. 4 depicts the flow directing system and compressor of FIG. 3, shown in partially exploded form;

FIG. 5 depicts a perspective view of an example of a volute casing member of the compressor of FIGS. 3 and 4;

FIG. 6 depicts an elevation view of an example of a volute nozzle liner of the flow directing system of FIGS. 3 and 4;

FIG. 7 depicts an elevation view of the cross-section of the flow directing system and compressor of FIG. 3;

FIG. 8 depicts a detail view of the cross-section of the flow directing system and compressor of FIG. 7;

FIG. 9 depicts a perspective view of the front of an example of a volute scroll of a flow directing system;

FIG. 10 depicts a perspective view of the back of the volute scroll of FIG. 9;

FIG. 11 depicts an elevation view of the cross-section of the flow directing system and compressor of FIG. 3; and

FIG. 12 depicts a flow diagram of an exemplary embodiment of a method to configure an exiting flowpath in a fluid displacement device.

Where applicable like reference characters designate identical or corresponding components and units throughout the several views, which are not to scale unless otherwise indicated. The embodiments disclosed herein may include elements that appear in one or more of the several views or in combinations of the several views. Moreover, methods are exemplary only and can be modified by, for example, reordering, adding, removing, and/or altering the individual stages.

### DETAILED DESCRIPTION

The discussion below describes embodiments of systems and methods that define a flowpath for fluid. Embodiments of the system can include a pair of members that define geometry for the flowpath. These members can reside in a compressor or other fluid displacement device to direct fluid, via the flowpath, out of the compressor as an exit flow to a process line. The members can be removed from the fluid displacement device, often independently of one another, and replaced with other members to change the geometry of the flowpath. This feature is useful to configure the geometry of the flowpath so as to maintain the operating efficiency of the fluid displacement device across a broader range of flow parameters for the exit flow.

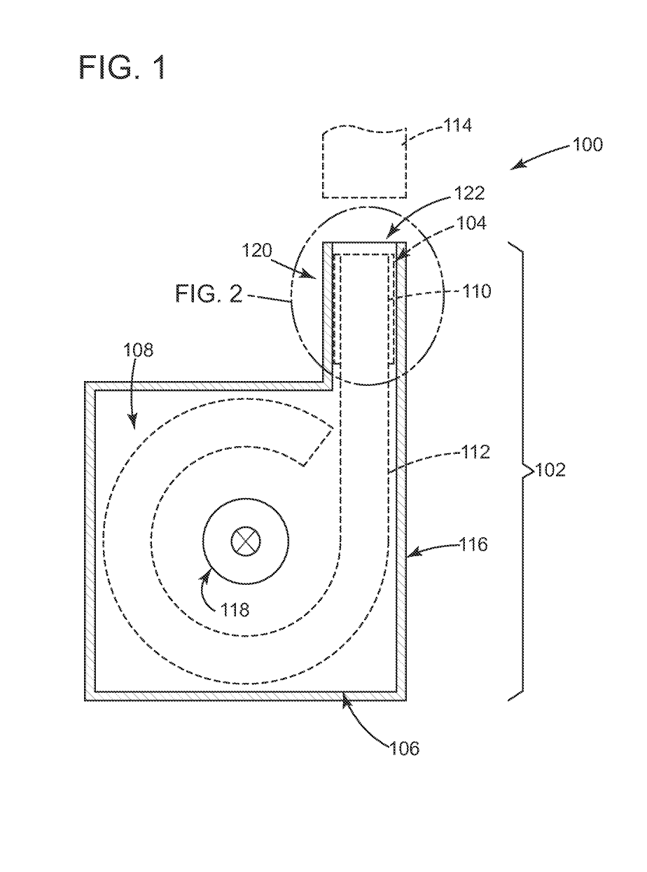

FIG. 1 illustrates a schematic diagram of an exemplary embodiment of a flow directing system 100 (also “system 100”). The system 100 can be disposed in a fluid displacement device, identified and described generally as a compressor 102. The system 100 can have one or more members (e.g., a volute nozzle liner 104 (also “first member 104) and a volute scroll 106 (also “second member 106”)), each being removeably replaceable from the compressor 102. The members 104, 106 can form an exiting flowpath 108. Examples of the exiting flowpath 108 can include a first flow portion 110 (also, “nozzle portion 110”) and a second flow portion 112 (also, “collector portion 112”), which together can direct working fluid from inside of the device 102 to discharge as an exit flow into a process line 114.

As shown in FIG. 1, the compressor 102 includes a volute casing member 116 and an impeller 118. The volute casing member 116 can have a discharge, shown here as a nozzle member 120 that defines a discharge flowpath 122. The nozzle member 120 is configured to couple with the volute casing member 116, operating to secure the compressor 102 with collateral members (e.g., piping and/or conduit) that are part of the process line 114. The nozzle portion 110 can extend at least partially into the discharge flowpath 122, although often the nozzle portion 110 can extend the entire length of the discharge flowpath 122. The collector portion 112 can be disposed in the volute casing member 116 and may at least partially circumscribe the impeller 118. When the members 104, 106 are installed together into the compressor 102, the portions 110, 112 define geometry for the exiting flowpath 108 so the compressor 102 discharges the exit flow at flow parameters desired for the process line 114.

Broadly, the members 104, 106 are configured to change the exiting flowpath 108 independent of other structure of the compressor 102. This other structure may include the volute casing member 116, the impeller 118, and/or the nozzle member 120. In one implementation, the members 104, 106 can removeably replace from the volute casing member 116 and the nozzle member 120. Bolts and/or suitably configured fasteners may be used to facilitate the exchange of one or both of the members 104, 106, either together (as a monolithic unit), individually (as separate pieces), and/or otherwise independently of one another. The members 104, 106 may form at least part of a “set” or “kit.” In one implementation, to reconfigure the exiting flowpath 108, a first set (or kit) of members 104, 106 can be removed from the compressor 102 in favor of a second set (or kit) of members 104, 106 that have different geometry for one or both of the flow portions 110, 112. As noted above, the new geometry modifies the exiting flowpath 108 to allow the compressor 102 to maintain operating efficiency using the impeller 118 across a broader range of flow parameters (e.g., flow rate, pressure, etc.) for the exit flow that the compressor 102 delivers to the process line 114.

Use of the system 100 can effectively avoid losses in operating efficiency for the compressor 102 that can be attributed, in part, to a mismatch between the frame size (e.g., diameter) of the impeller 118, the exiting flowpath 108, and/or the flow parameters desired for the exit flow. These losses can be at least approximately 2.5% or more. Such losses are normally overlooked but, if recovered, can result in better and more robust performance of the compressor 102 across the operating range. Moreover, the system 100 allows the dimensions for the volute casing member 116 to be standardized for use with different geometry of the exiting flowpath 108 and different frame sizes for the impeller 118. This feature is beneficial at least to modularize assembly of the compressor 102, which can benefit applications to retrofit, refurbish, and/or re-purpose the compressor 102 at minimal costs for parts and deployment of labor.

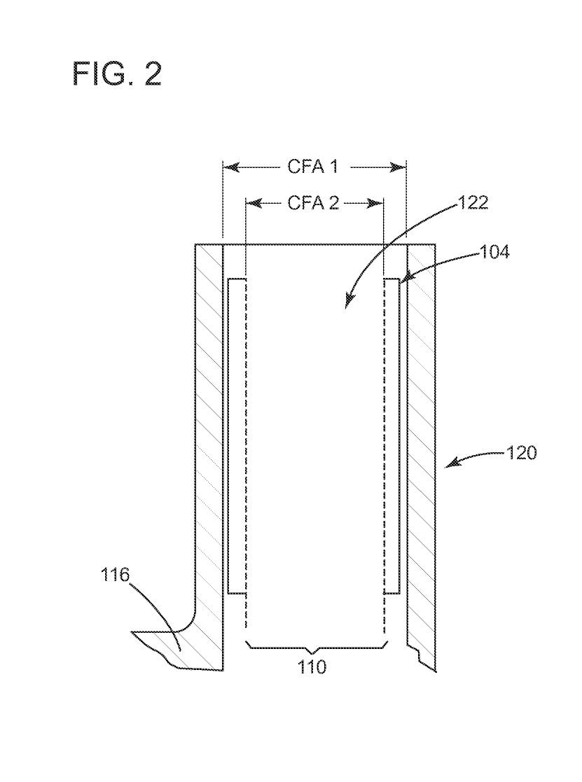

FIG. 2 shows a detail view of the nozzle member 120 on the compressor 102 of FIG. 1. The discharge flowpath 122 defines a first cross-sectional area (CFA1), which is typically fixed by the construction of the nozzle member 120. The volute nozzle liner 104 inserts into the nozzle member 120 to reduce one or more dimensions of the discharge flowpath 122. In one example, the nozzle portion 110 defines a second cross-sectional flow area (CFA2) that is smaller than the first cross-sectional flow area (CFA1) of the discharge flowpath 122. The reduction in the cross-sectional flow area aligns the discharge flowpath 122 with the configuration of the collector portion 112 (FIG. 1). In this way, the compressor 102 (FIG. 1) is configured to avoid losses (in pressure and/or flow rate) and maintain operating efficiencies of the compressor 102 (FIG. 1) necessary to achieve the desired setpoints with the impeller 118 and, also, in lieu of changes to the volute casing member 116. As noted more below, the second cross-sectional area (CFA2) of the nozzle portion 110 decreases from a first end to a second end proximate an opening in the volute casing member 116.

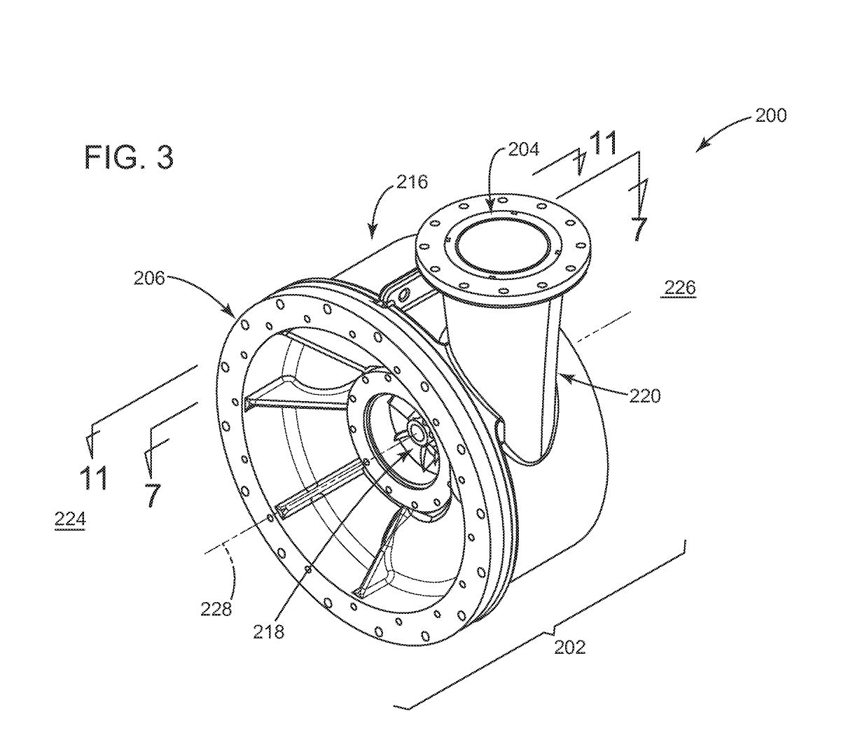

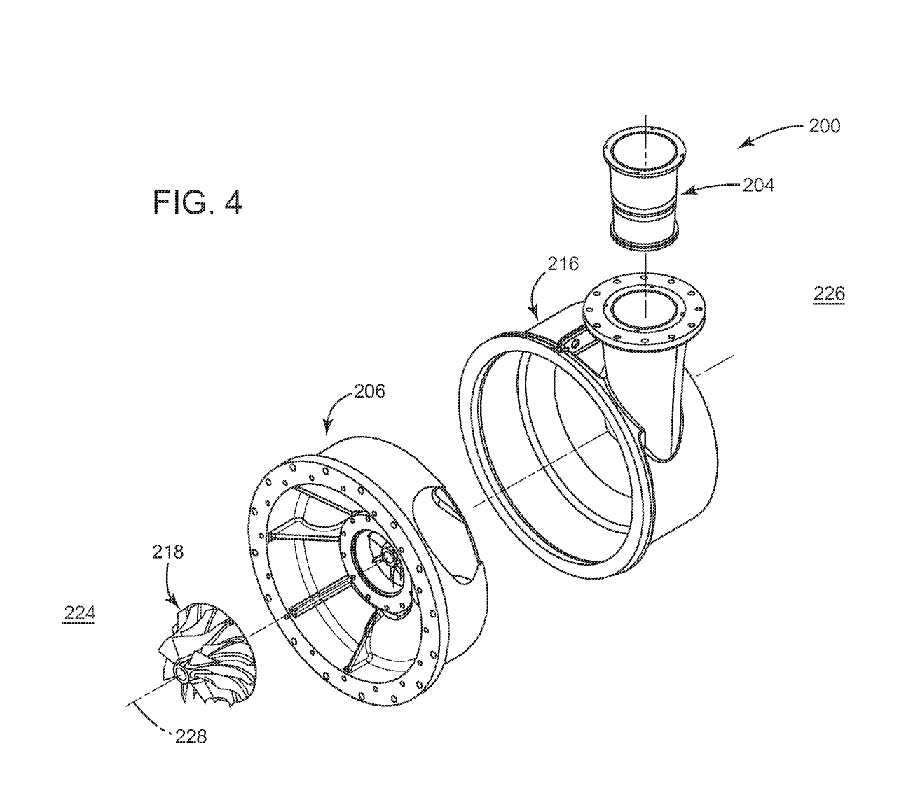

FIGS. 3 and 4 illustrate a perspective view of an exemplary embodiment of a flow directing system 200 (also, “system 200”) as part of a compressor 202 in partially-assembled form (FIG. 3) and partially-exploded form (FIG. 4). Some parts of the compressor 202 have been omitted for clarity. The compressor 202 has a first side 224 (also, “an inlet side 224”), a second side 226 (also, “a back side 226”), and a longitudinal axis 228 extending therebetween. The compressor 202 can also include a mechanical drive assembly (not shown) that rotates the impeller 218. This action draws a working fluid into the compressor 202. The mechanical drive assembly can include a drive unit with a gearbox/shaft. Examples of the drive unit include steam turbines, gas turbines, and electric motors. During operation, rotation of the impeller 218 compresses the working fluid. The members 204, 206 configure the compressor 202 to direct the compressed working fluid from the impeller 218 to discharge as the exit flow from the nozzle member 220.

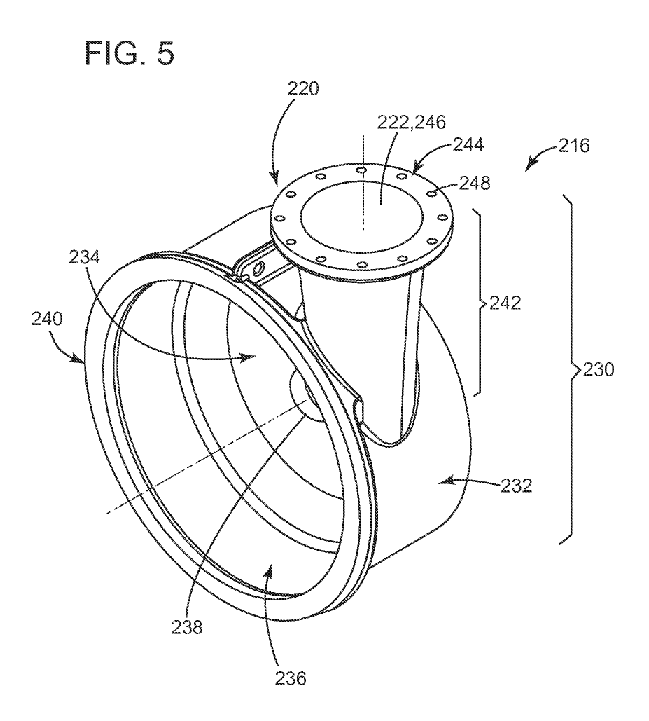

FIG. 5 illustrates a perspective view of the volute casing member 216. Examples of the volute casing member 216 can have a casing body 230 forming a stout, cylindrical structure of generally annular or circular geometry. This structure can have several constituent members that secure together to form a welded and/or bolted frame or like structure. The frame can support the members 204, 206 and the impeller 218. In one example, the constituent members can include a peripheral casing wall 232 that couples with a back casing wall 234 to form a first interior cavity 236. The back casing wall 234 can include a central opening 238 to allow the mechanical assembly to couple with the impeller 218. Opposite the back casing wall 234, the peripheral casing wall 232 terminates at an outwardly-facing casing flange member 240.

The nozzle member 220 has an elongated nozzle body 242 that extends transversely away from the casing body 230. The elongated nozzle body 242 can have a distal end proximate the peripheral casing wall 232 and a proximal end with a nozzle flange member 244. At the distal end, the elongated nozzle body 242 can be formed integrally with the casing body 230, although in some configurations, the elongated nozzle body 242 is constructed separately. Construction of the elongated nozzle body 242 may leverage properly formed sheet metal for the elongated nozzle body 242. This formed sheet metal construction can result in a tubular shape that can secure in place (on the peripheral casing wall 232) using conventional fastening techniques (e.g., bolts, welds, etc.). The tubular shape forms the discharge flowpath 222. At the proximal end, the discharge flowpath 222 terminates at a discharge opening 246. The nozzle flange member 244 forms a mating surface with one or more bolt openings 248. Examples of the bolt openings 248 can include annular and slotted features that penetrate into and/or through the material thickness of the nozzle flange member 244.

The nozzle flange member 244 can form a connection that couples the compressor 202 with the process line 114 (FIG. 1). The mating surface of the nozzle flange member 244 can be approximately flat and/or planar. This geometry may be useful to properly seal with the adjacent collateral member(s) of the process line 114 (FIG. 1) at the connection. In one example, a seal or other like compressible member may at least partially circumscribes the discharge opening 246 to prevent leakage of working fluid from the connection. The bolt openings 248 can accommodate bolts and/or fasteners to secure the process piping and conduits to the nozzle member 220. As discussed more below, both the discharge flowpath 222 and the discharge opening 246 can be configured to receive the volute nozzle liner 204 (FIGS. 3 and 4) therein.

The casing body 230 is configured to receive and support the volute scroll 206. The casing flange member 240 can serve as an interface for mounting the volute scroll 206 to the casing body 230. In one implementation, the volute scroll 206 can insert into the first interior cavity 236, abutting the casing flange member 240 and spaced apart from the back casing wall 234, as discussed more below. One or more bolts can penetrate each of the volute scroll 206 and the casing flange member 240 to releasably secure these components together. In one example, the central opening 238 allows the mechanical drive assembly and the impeller 218 to mate with one another in the compressor 202.

With reference also to FIGS. 3 and 4, the casing body 230 can have dimensions (also, “casing dimensions”) that are fixed for use across different configurations for the compressor 202. These configurations can define the geometry for the collector portion 112 (FIG. 1) and/or a frame size for the impeller 218. The geometry for the collector portion 112 (FIG. 1) can be associated with the configuration of the volute scroll 206. The frame size may vary for the compressor 202 to achieve flow parameters required for the process line 114 (FIG. 1). For example, the impeller 218 may assume a first frame size (also, “maximum frame size”) that describes the largest diameter for the impeller 218. The impeller 218 may also assume a second frame size, which is different from the first frame size and, often, describes a smaller diameter for the impeller 218 as measured relative to the largest diameter. As noted herein, to simplify construction of the compressor 202, the volute scroll 206 in the sets (or kits) can be used to match the geometry for the collector portion 112 (FIG. 1) and/or the nozzle portion 110 (FIG. 1) to the frame size as well as to meet the specifications for the compressor 202.

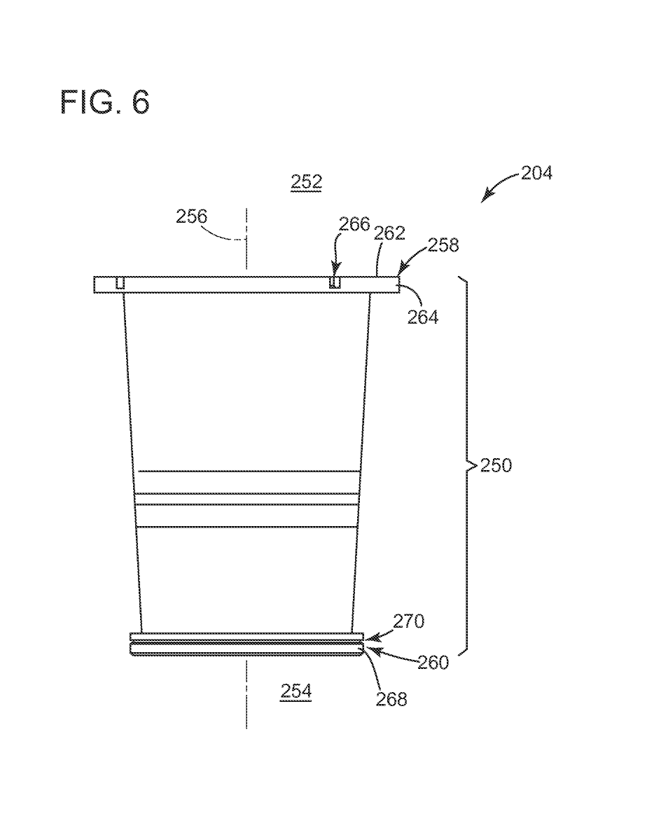

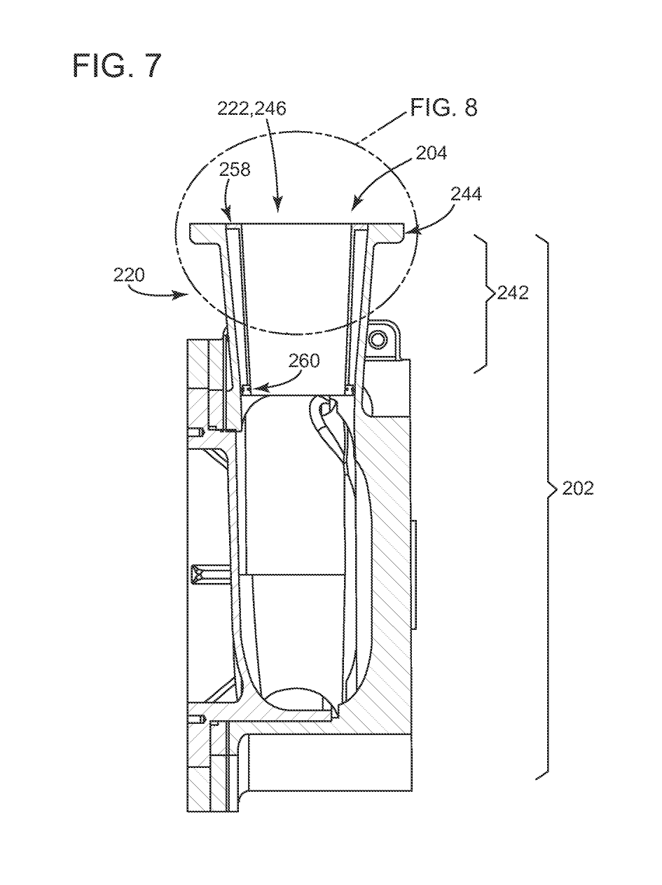

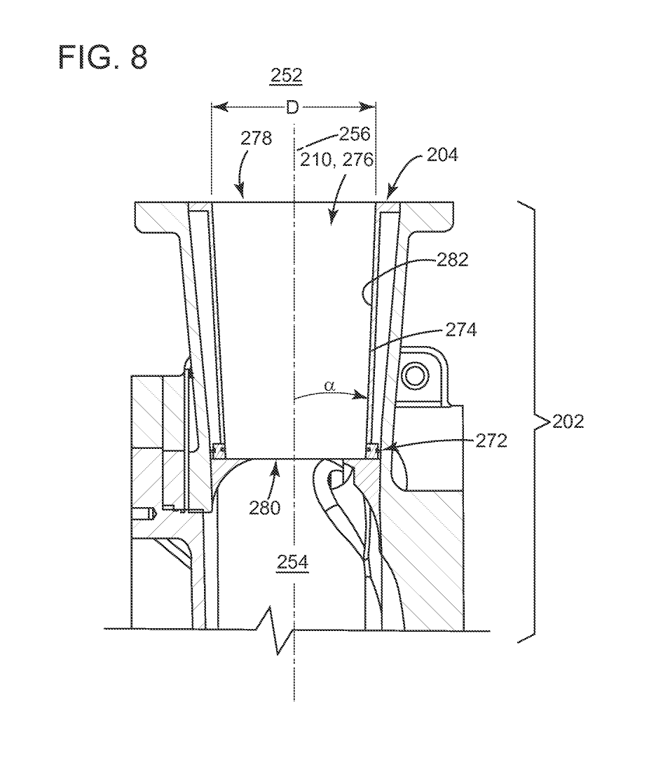

FIGS. 6, 7, and 8 illustrate various views of an example of the volute nozzle liner 204. FIG. 6 depicts an elevation view of the volute nozzle liner 204. FIG. 7 depicts an elevation view of the cross-section of the compressor 202 taken at line 7-7 of FIG. 3. FIG. 8 provides a detail view of the volute nozzle liner 204 in FIG. 7.

Referring first to FIG. 6, the volute nozzle liner 204 has a volute nozzle liner body 250 with a first end 252, a second end 254, and second longitudinal axis 256 (also, “central axis 256”) extending therebetween. The volute nozzle liner body 250 can form a generally elongated cylinder with a pair of flange members (e.g., a first flange member 258 and a second flange member 260) disposed at each of the ends 252, 254. In use, the flange members 258, 260 are configured to engage one or more interior surfaces of the elongated nozzle body 242 (FIG. 5). Such engagement locates the volute nozzle liner 204 in position to receive the flow of working fluid during operation of the compressor 202 (FIGS. 3 and 4).

At the top or first end 252, the first flange member 258 has a top surface 262 and a first peripheral outer surface 264. The first peripheral outer surface 264 can incorporate threads that engage corresponding threads on the elongated nozzle body 242 (FIG. 5). The top surface 262 can be approximately flat or planar. When the volute nozzle liner 204 is assembled into the elongated nozzle body 242 (FIG. 5), this geometry may be advantageous for the top surface 262 to remain flush with the approximately planar mating surface of the nozzle flange member 244 (FIG. 5).

The top surface 262 of the first flange member 258 can have one or more fastening detents 266 disposed therein. The fastening detents 266 are configured to receive tooling (e.g., a spanner wrench). This tooling is useful to manipulate the volute nozzle liner 204 into position; for example, the tooling may operate as an aid for the end user to rotate and tighten the volute nozzle liner 204 into position in the elongated nozzle body 242 (FIG. 5). In one implementation, the fastening detents 266 can be distributed circumferentially around the second longitudinal axis 256, possibly spaced equally apart on the top surface 262 to provide various points of access for the tooling. The fastening detents 266 may embody openings that penetrate into and/or through the material of the first flange member 258, as shown in FIG. 6. In other implementations, the fastening detents 266 may embody protrusions that extend from the top surface 262 or, where applicable, the fastening detents 266 may embody combinations of features (e.g., openings, protrusions, etc.) that facilitate use and installation of the volute nozzle liner 204 as contemplated herein.

Referring back to FIG. 6, the second flange member 260 has an second peripheral outer surface 268 that is configured to create a seal with the interior surface of the elongated nozzle body 242 (FIG. 5). The second peripheral outer surface 268 may have a groove 270, which can penetrate into the material of the second flange member 260. Dimensions for the groove 270 are configured to receive o-rings, gaskets, and or like compressible member. These dimensions position the compressible member on the second flange member 260 to crush to form the seal with the volute nozzle liner 204 installed in the elongated nozzle body 242 (FIG. 5). This disclosure does, however, contemplate various configurations in which the seal forms through metal-to-metal or other material contact between the second flange member 260 and the interior surface of the elongated nozzle body 242 (FIG. 5).

FIG. 7 shows the cross-section of the compressor 202 in its entirety. The volute nozzle liner 204 inserts into the discharge opening 246 of the nozzle member 220. The second flange member 260 can be disposed inwardly of the discharge flowpath 222 and proximate the distal end of the elongated nozzle body 242. In this position, the first flange member 258 resides proximate the nozzle flange member 244. The threads on the first flange member 258 can mate with corresponding threads on the interior of the nozzle flange member 244 (or other suitably oriented surface of the nozzle member 220). In one implementation, rotating the volute nozzle liner 204 will engage the threads to drive the volute nozzle liner 204 distally into the elongated nozzle body 242. When in position, distal progress of the volute nozzle liner 204 into the elongated nozzle body 242 will stop, for example, due to the interference fit between second flange member 260 and the interior surface of the elongate nozzle body 242.

FIG. 8 shows a detail view of the compressor 202 in FIG. 7 to focus on the volute nozzle liner 204. The volute nozzle liner 204 includes a seal member 272, shown here as an annular o-ring that fits into the groove 270 (FIG. 6) on the distal flange member 260 (FIG. 6). The volute nozzle liner body 250 has a peripheral wall 274 that bounds a central bore 276 (also, “first bore 276”) that defines at least part of the nozzle portion 210. The central bore 276 can have openings (e.g., a first opening 278 and a second opening 280) at each of the ends 252, 254. The central bore 276 can assume a circular or annular shape, although this disclosure does contemplate other shapes (e.g., square, rectangular, elliptical, etc.). The peripheral wall 274 may be thin, as shown, in keeping with tubular construction that may be of sheet metal that is bent or formed annularly about the second longitudinal axis 256. The tubular construction can define the shape of the central bore 276. In other configurations, the profile and shape of the peripheral wall 274 and the central bore 276 may be machined from a single piece (also, “block” or “billet”) of material, typically aluminum, steel, stainless steel, and the like machined metals (e.g., aluminum, steel, etc.). The flange members 258, 260 can be formed integrally with the volute nozzle liner body 250 or as separate pieces that are fastened to the peripheral casing wall 232 (FIG. 5) using convention fastening techniques (e.g., welding, bolting, etc.).

As also shown in FIG. 8, the central bore 276 has a surface (e.g., an interior bore surface 282) that defines the dimensions of the central bore 276 between the openings 278, 280. For circular shapes, the central bore 276 can have a diameter D measured relative to the second longitudinal axis 256. The diameter D has a first diameter at the first opening 278 and a second diameter at the second opening 280. In one example, the first diameter is larger than the second diameter. The interior bore surface 282 may taper inwardly toward the second longitudinal axis 256 and in a direction along the second longitudinal axis 256 from the first opening 278 to the second opening 280. The taper reduces the diameter D along the second longitudinal axis 256, causing the nozzle portion 210 to diverge in a direction from the second end 280 to the first end 278. The amount or degree of the taper is defined by an angle α (also “cone angle) as measured relative to the second longitudinal axis 256. In use, the cone angle can be the same as the cone angle for the interior nozzle surface of the elongated nozzle body 242. Values for the cone angle are often in a range of approximately 10° to approximately 12°.

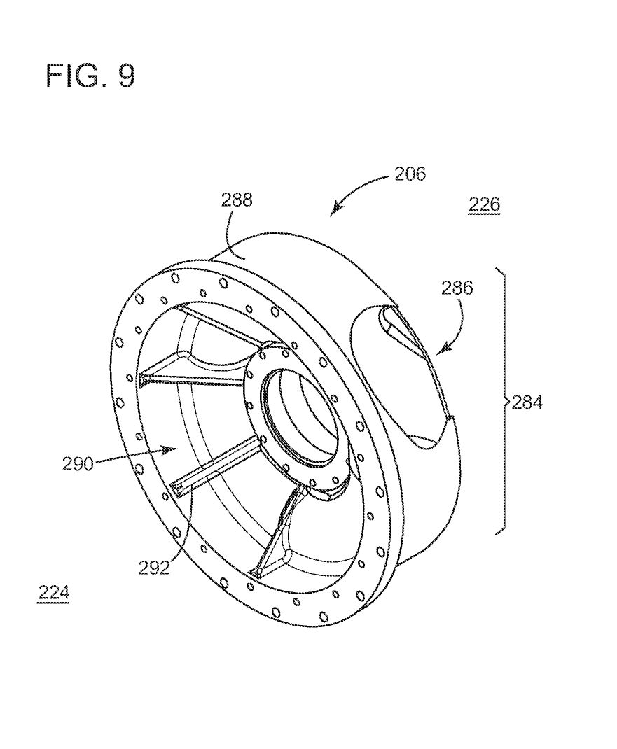

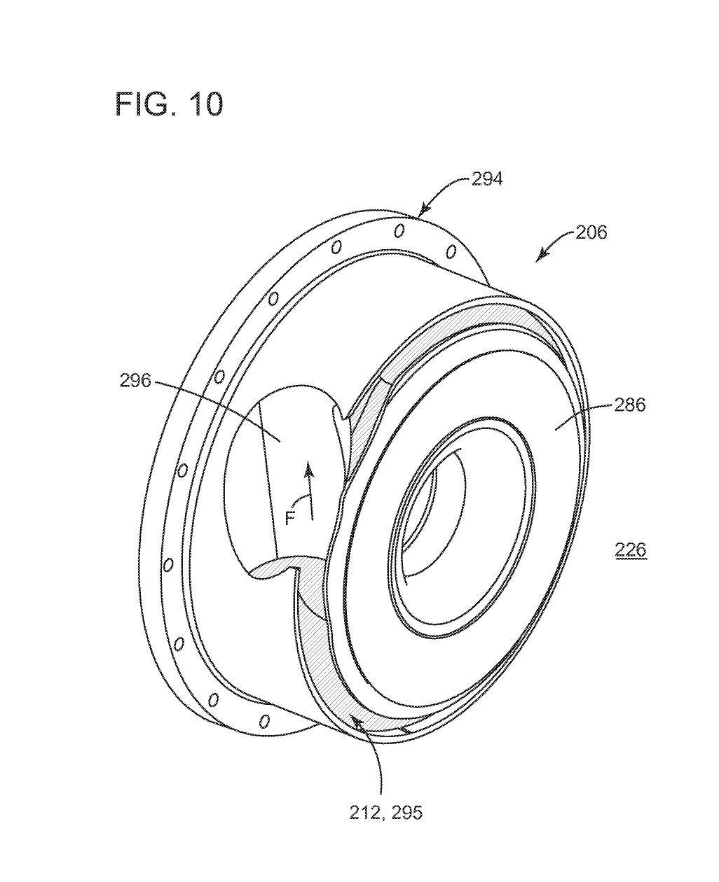

FIGS. 9 and 10 illustrate an example of the volute scroll 206. FIG. 9 shows a perspective view from the first or inlet side 224 of the compressor 202 (FIGS. 3 and 4). The volute scroll 206 has a volute scroll body 284 also having a stout, cylindrical structure of generally annular or circular geometry. In connection with the discussion herein, this geometry is useful to allow the volute scroll 206 to insert into the first interior cavity 236 (FIG. 5) on the casing body 230 (FIG. 5).

Construction of the volute scroll body 284 may leverage multiple pieces that couple together to form a frame and/or like structure, although machining may be required to form all or parts of the geometry of the volute scroll 206, as necessary. In one example, the frame has a first section with a back wall member 286 that couples with a peripheral scroll wall member 288. Together, the members 286, 288 form a second interior cavity 290. Inside of the second interior cavity 290, the volute scroll 206 can include one or more flow elements 292, possibly vanes of aerodynamic shape and circumferentially-spaced about the periphery of the second interior cavity 290. The vanes may be welded in place on the peripheral scroll wall member 288, although bolts and like fasteners may satisfy construction. These vanes modify the flow of the working fluid that passes through the volute scroll 206 during operation of the compressor 202 (FIG. 3).

FIG. 10 shows a perspective view from the second or back side 226 of the compressor 202 (FIG. 4). The frame has a second section of larger diameter than the first section. This second section has an outwardly-facing scroll flange member 294. Holes in the scroll flange member 294 may be useful to receive fasteners that secure the volute scroll 206 to the volute casing member 216 (FIGS. 3 and 4). The back wall member 286 is configured with an annular flowpath 295 that forms at least part of the collector portion 212. The annular flowpath 295 terminates at a scroll discharge opening 296. The scroll discharge opening 296 can couple the collector portion 212 with the nozzle portion 210 (FIG. 8) (e.g., via the elongated nozzle body 242 (FIG. 7)) to discharge the compressed exit flow to the process line 114 (FIG. 1).

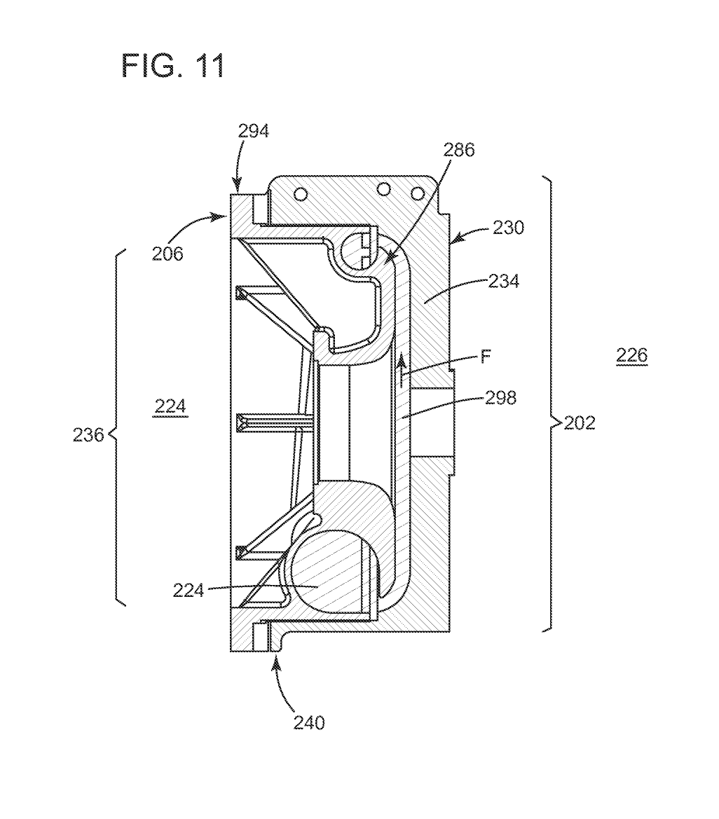

The annular flowpath 295 features a bore (also, “second bore”) of generally circular diameter. The second bore can at least partially circumscribe the longitudinal axis 228 (FIGS. 3 and 4) and, when assembled, the impeller 218 (FIGS. 3 and 4) and/or the opening 238 (FIG. 5). Each of the first bore of the volute nozzle liner 204 and the second bore of the volute scroll 206 are configured to form the exiting flowpath 108 (FIG. 1) to direct working fluid from inside of the volute casing member 216 (FIG. 3) to the first opening 278 of the volute nozzle liner 204. The diameter of the second bore may increase from a first end proximate the impeller 218 (FIGS. 3 and 4) to a second end proximate the scroll discharge opening 296 or, in one example, moving downstream from the impeller 218 (FIGS. 3 and 4) and towards the scroll discharge opening 296. The increasing diameter is useful to modulate the flow rate and pressure of the working fluid F. In one implementation, the annular flowpath 295 has a portion that is at least partially open on the back side 226 of the back wall member 286. This open portion exposes the interior of the second bore to collect fluid into the annular flowpath 295, as discussed more below and shown in FIG. 11.

FIG. 11 illustrates an elevation view of the cross-section of the compressor 202 taken at line 11-11 of FIG. 3. The first section of the volute scroll 206 fits inside of the first interior cavity 236 of the casing body 230. The scroll flange member 294 contacts the casing flange member 240, operating effectively as a hard stop during manufacture and/or assembly of the system 200 in the compressor 202. In one implementation, the system 200 includes fasteners (e.g., bolts) that pass through both the casing flange member 240 and the scroll flange member 294 to secure these pieces together. This configuration also allows the volute scroll 206 to releaseably remove from the casing body 230 to facilitate reconfiguration of the compressor 202 for different flow parameters as noted herein. The hard stop positions the back wall member 286 in spaced relation to the back casing wall 234 at the back side 226. This configuration forms an intermediary flow path 298 between the back casing wall 234 of the volute casing member 216 and the back wall member 286 of the volute scroll 206. The intermediary flow path 298 couples with the open portion of the bore of the annular flowpath 295 (FIG. 10) on the backwall member 286 of the volute scroll 206, thus allowing working fluid F to enter into the collector portion 212 of the exiting flowpath 108 (FIG. 1) in accordance with the direction of rotation of the impeller 218 (FIGS. 3 and 4) during operation of the compressor 202.

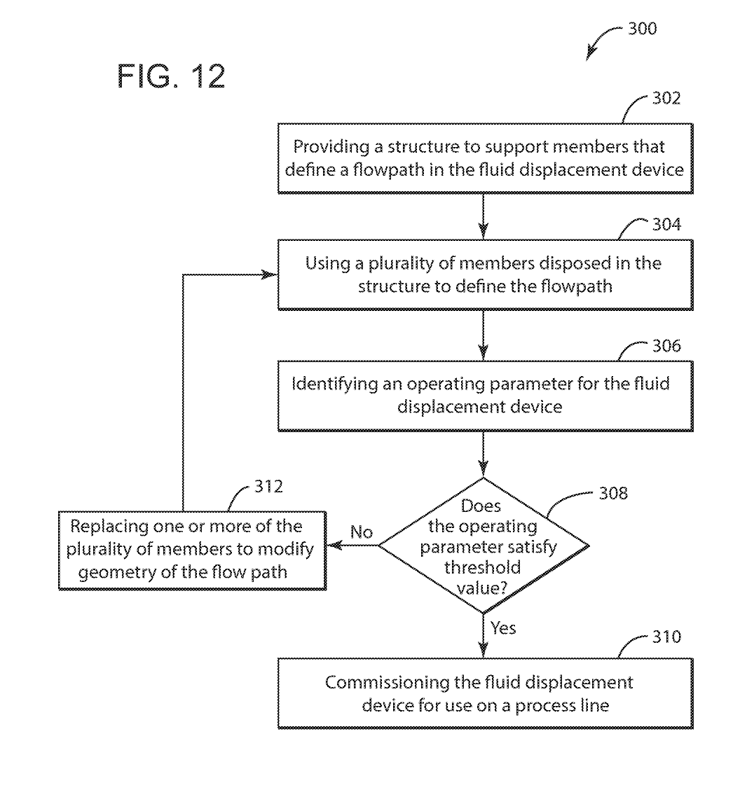

FIG. 12 depicts a flow diagram for an exemplary embodiment of a method 300 to configure a fluid displacement device to direct fluid from an inlet to a discharge. The method 300 includes, at stage 302, providing a structure to support members that define a flowpath in the fluid displacement device and, at stage 304, using a plurality of members disposed in the structure to define the flowpath. In one implementation, the plurality of members can include a first member and a second member that are removeably replaceable from the fluid displacement device independent of one another. The method 300 can also include, at stage 306, identifying an operating parameter for the fluid displacement device and, at stage 308, comparing the operating parameter to a threshold value. The operating parameter and the threshold value can quantify efficiency and/or other value that is a reliable indicator of the performance of the fluid displacement device. In one example, the method 300 may include one or more stages for operating the fluid displacement device to gather data to determine the operating parameter, although this disclosure also contemplates implementations in which the operating parameter can be simulated via a computing device. As also shown in FIG. 12, if the operating parameter satisfies the threshold value, then the method 300 can include, at stage 310, commissioning the fluid displacement device for use, e.g., on a process line. On the other hand, if the operating parameter does not satisfy the threshold value, then the method 300 can include, at stage 312, replacing one or more of the plurality of members to modify geometry of the flowpath. As noted above, the first member and the second member may be part of matched “set,” wherein a first set of the members can be removed from the fluid displacement device in favor of a second set of members to change the geometry of the flowpath.

This disclosure contemplates various embodiments of the method 300, which may include one or more clauses, alone and or in combination, a sample of such clauses exemplified hereinbelow:

A1. A method comprising using a first member to define a first portion of a flowpath in the fluid displacement device and using a second member to define a second portion of the flowpath upstream of the first portion in the fluid displacement device, wherein the first member and the second member are removeably replaceable from the fluid displacement device independent of one another.

A2. The method of A1, further comprising replacing one of the first member or the second member to modify geometry of the flowpath.

A3. The method of A1, further comprising replacing both the first member and the second member to modify geometry of the flowpath.

A4. The method of A1, further comprising identifying an operating parameter for the fluid displacement device, comparing the operating parameter to a threshold value, and replacing one or more of the first member and the second member according to a relationship between the operating parameter and the threshold value.

A5. The method of A1, wherein the first member resides in a nozzle member on a compressor.

A6. The method of A5, wherein the second portion resides in a casing member on the compressor.

In light of the foregoing discussion, the embodiments herein can simplify construction of compressors. This feature can modularize the assembly, reducing the number of parts necessary to assembly compressors for different applications. As noted herein, the proposed construction also configures compressors to more easily be adapted, or reconfigured, for use in different applications.

As used herein, an element or function recited in the singular and proceeded with the word “a” or “an” should be understood as not excluding plural said elements or functions, unless such exclusion is explicitly recited. Furthermore, references to “one embodiment” of the claimed subject matter should not be interpreted as excluding the existence of additional embodiments that also incorporate the recited features.

This written description uses examples to disclose the subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A flow directing system for defining an exiting flowpath in a fluid displacement device, said flow directing system comprising:
a first member configured with a first portion of an exiting flowpath, the first member configured to releaseably secure at a nozzle member of the fluid displacement device; and
a second member configured with a second portion of the exiting flowpath that is longer than the first portion, the second member configured to releaseably secure to a casing member of the fluid displacement device.

2. The flow directing system of claim 1, wherein the first member has a first bore that forms the first portion of the exiting flowpath, the first bore having a first axis and an interior bore surface that circumscribes the first axis and that tapers inwardly toward the first axis from a first opening to a second opening.

3. The flow directing system of claim 2, wherein the first member has a first end and a second end proximate the first opening and the second opening, respectively, and wherein the first member is configured to insert into the nozzle member with the second end located upstream of the first end in the nozzle member.

4. The flow directing system of claim 1, wherein the second member has an annular casing body with a back casing wall having an opening, wherein the back casing wall comprises an annular flowpath that forms the second portion, and wherein the annular flowpath circumscribes the opening.

5. The flow directing system of claim 4, wherein the annular flowpath has a portion that is at least partially open on a back side of the back casing wall.

6. A fluid displacement device, comprising:
a volute casing member with a nozzle member; and
a flow directing system disposed in the volute casing member, the flow directing system comprising a first member and a second member, each being removebly replaceable from the volute casing member, the first member and the second member forming an exiting flowpath that is configured to direct working fluid from inside of the volute casing member to the nozzle member.

7. The fluid displacement device of claim 6, wherein the first member and the second member are removeably replaceable from the volute casing member independent of one another.

8. The fluid displacement device of claim 6, wherein the volute casing member comprises a casing body, wherein the nozzle member defines a discharge flowpath that extends transversely away from the casing body, and wherein the exiting flowpath has a first portion that extends at least partially into the discharge flowpath.

9. The fluid displacement device of claim 7, wherein the discharge flowpath defines a first cross-sectional area and the first portion of the exiting flowpath defines a second cross-sectional area that is smaller than the first cross-sectional area.

10. The fluid displacement device of claim 7, wherein the second cross-sectional area of the first portion decreases from a first end to a second end proximate the discharge opening in the casing body.

11. The fluid displacement device of claim 7, wherein the exiting flowpath has a second portion disposed in the volute casing member that terminates at a discharge opening in the casing body.

12. The fluid displacement device of claim 7, wherein the cross-sectional area of the second portion increases from a first end to a second end proximate the discharge opening.

13. The fluid displacement device of claim 7, wherein the second portion forms an annular flowpath.

14. The fluid displacement device of claim 7, wherein the first member and the second member are configured to form the first portion and the second portion of the exiting flowpath, respectively.

15. The fluid displacement device of claim 7, further comprising an impeller disposed in the volute casing member, wherein the annular flowpath at least partially circumscribes the impeller.

16. A fluid displacement device, comprising:
a volute casing member having a casing body with a elongated nozzle body extending therefrom, the casing body having a peripheral casing wall forming an interior cavity;
a first member disposed in the elongated nozzle body, the first member having a first bore with a first opening and a second opening; and
a second member disposed in the interior cavity, the second member having a second bore that circumscribes the longitudinal axis,
wherein each of the first member and the second member are removably replaceable from each of the casing body and the elongated nozzle body, respectively, independent of one another.

17. The fluid displacement device of claim 16, wherein the first bore has a first axis and an interior bore surface that circumscribes the first axis and that tapers inwardly toward the first axis from the first opening to the second opening.

18. The fluid displacement device of claim 17, wherein the interior bore surface tapers at a cone angle measured relative to the first axis that is the same as the cone angle for the interior nozzle surface of the elongated nozzle body.

19. The fluid displacement device of claim 16, wherein each of the first bore and the second bore are configured to form an exiting flowpath that is configured to direct working fluid from inside of the casing member to the first opening of the first member.

20. The fluid displacement device of claim 16, wherein the first member forms a seal with the elongated nozzle body proximate the second end.
